(19) United States
(12) Patent Application Publication
(10) Pub. No.: US 2025/0295228 A1
(43) Pub. Date: Sep. 25, 2025

(54) COUPLER WITH UPPER AND LOWER COUPLINGS, FUNCTIONAL MODULE, CART BODY AND DINING CART

(71) Applicant: Deson Hospitality Equipment Design (Shenzhen) Co., Ltd., Shenzhen (CN)

(72) Inventor: Fang Zhao, Shenzhen (CN)

(73) Assignee: Deson Hospitality Equipment Design (Shenzhen) Co., Ltd., Shenzhen (CN)

(21) Appl. No.: 18/896,245

(22) Filed: Sep. 25, 2024

(30) Foreign Application Priority Data
Mar. 25, 2024 (CN) 202420595810.5

(51) Int. Cl. A47B 31/00; A47J 36/00; A47J 36/24; B62B 3/02; B62B 5/00

(52) U.S. Cl. CPC A47B 31/00; A47J 36/00; A47J 36/24; B62B 3/02; B62B 5/00; A47B 2031/002; A47J 2201/00

(57) ABSTRACT

The present application discloses a coupler with upper and lower couplings, a functional module, a cart body and a dining cart. The coupler includes an upper coupling arranged on a functional module and a lower coupling arranged on a cart body. The upper coupling is provided with pins and a first limiting structure arranged around the periphery of the pins, the lower coupling is provided with jacks and a second limiting structure adapted to the first limiting structure, and during coupling, the pins are inserted into the jacks, and the first limiting structure is clamped in the second limiting structure to form locking to restrict the upper coupling from moving.

### CROSS REFERENCE TO RELATED APPLICATION

This application claims priority to Chinese Patent Application No. 202420595810.5, filed on Mar. 25, 2024, the entire content of which is incorporated herein by reference.

### TECHNICAL FIELD

The present application relates to the field of coupler devices, and in particular to a coupler with upper and lower couplings, a functional module, a cart body and a dining cart.

### BACKGROUND

The statements herein only provide background information related to the present application and do not necessarily constitute the prior art.

Plugs and sockets with power cords are widely used, such as dining carts with detachable functional modules. Station bodies and the functional modules of these dining carts are detachably arranged and thus these dining carts can satisfy current needs of users by replacing different functional modules. The plug is arranged on the functional module and the socket is arranged on the cart body. When the functional module and the cart body are assembled, a circuit needs to be connected. Therefore, the user needs to squat down to pull the power cord with the plug, and then plug the plug into the socket, leading to complex installation of the cart body and functional module. Meanwhile, the functional module cannot be positioned by the plug and the socket.

### SUMMARY

A main objective of the present application is to provide a coupler with upper and lower couplings, which is configured for a dining cart with a modular matching function. The dining cart includes a cart body and a functional module, and the functional module is detachably arranged on the cart body. The coupler includes an upper coupling and a lower coupling, the upper coupling is arranged on the functional module, and the lower coupling is correspondingly arranged on the cart body. The upper coupling is provided with pins and a first limiting structure arranged around the periphery of the pins, the lower coupling is provided with jacks for insertion of the pins and a second limiting structure adapted to the first limiting structure. During coupling, the pins of the upper coupling are inserted into the jacks of the lower coupling, and the first limiting structure is clamped in the second limiting structure to form locking to restrict the upper coupling from moving.

According to the present application, the upper coupling is provided with the first limiting structure and the lower coupling is provided with the second limiting structure adapted to the first limiting structure, so that when the upper coupling and the lower coupling are coupled, the pins of the upper coupling are inserted into the jacks of the lower coupling to realize electrification; and the first limiting structure is clamped in the second limiting structure to form locking to restrict the upper coupling from moving. Since the upper coupling is fixed on the functional module, the functional module is positioned. The functional module and the cart body are connected together through the upper coupling and the lower coupling of the coupler, so that the installation of the functional module and the cart body is simpler, and there is no need for the user to squat down to pull the power cord with the plug, and then insert the plug into the socket.

### BRIEF DESCRIPTION OF THE DRAWINGS

One or more embodiments are exemplarily illustrated with reference to accompanying drawings corresponding thereto, and these exemplary illustrations do not constitute a limitation to the embodiments. Elements with the same reference numerals in the drawings represent similar elements, and unless otherwise specified, the figures in the accompanying drawings do not constitute a scale limitation.

FIG. 1 is a schematic diagram of assembling of a functional module and a coupler according to the present application;

FIG. 2 is a partially enlarged exploded side view of assembling of a functional module and a coupler according to the present application;

FIG. 3 is a schematic diagram of assembling of a cart body and a coupler according to the present application;

FIG. 4 is a schematic exploded view of assembling of a dining cart and a coupler according to the present application;

FIG. 5 is a schematic diagram of assembling of a dining cart and a coupler according to the present application;

FIG. 6 is a schematic sectional view of a coupler according to an embodiment of the present application;

FIG. 7 is a schematic structural diagram of a coupler according to an embodiment of the present application;

FIG. 8 is an exploded schematic structural diagram of a coupler according to an embodiment of the present application;

FIG. 9 is a schematic structural diagram of a lower coupling;

FIG. 10 is a schematic structural diagram of an upper coupling;

FIG. 11 is a schematic structural diagram of an upper coupling with flat pins vertically distributed side by side;

FIG. 12 is a schematic structural diagram of an upper coupling with flat pins horizontally distributed side by side;

FIG. 13 is a schematic structural diagram of an upper coupling with circular pins;

FIG. 14 is a side view of an upper coupling;

FIG. 15 is a side view of a first limiting structure from a perspective; and

FIG. 16 is a side view of a first limiting structure from another perspective.

### DETAILED DESCRIPTION

In order to facilitate the understanding of the present application, the present application is described in more detail below in connection with the accompanying drawings and specific embodiments. It should be noted that when an element is expressed to be “secured to” another element, said element may be directly disposed on said another element, or there may be one or more intermediate elements therebetween. When an element is expressed to be “attached” to another element, said element may be directly attached to said another element, or there may be one or more intermediate elements therebetween. The terms “vertical”, “horizontal”, “left”, “right”, “inside”, “outside” and similar expressions are used in this description for illustrative purposes only. In the description of the present application, the terms “first” and “second” are used only for descriptive purposes and are not to be construed as indicating relative importance or implicitly specifying the number of technical features indicated. Accordingly, unless otherwise indicated, a feature defined with “first”, “second” may expressly or impliedly include one or more such features; “a plurality of” means two or more, more than two. The term “include” and any variations thereof are intended to express a non-exclusive inclusion, and one or more other features, integers, steps, operations, units, components and/or combinations thereof may be present or added.

Furthermore, unless otherwise expressly provided and defined, the terms “mounted”, “coupled”, “connected” are to be understood in a broad sense, e.g. a fixed connection, a detachable connection, or an integral connection; a mechanical connection or an electrical connection; a direct connection or an indirect connection through an intermediate medium or as a connection within two elements. All technical and scientific terms used in this description have the same meaning as commonly understood by those skilled in the art belonging to this application. The terms used in the description of this application are used only for the purpose of describing specific embodiments and are not intended to limit this application. The term “and/or” as used in this description includes any and all combinations of one or more of the relevant listed items.

In addition, the technical features involved in the different embodiments of the present application described below may be combined with each other as long as they do not conflict with each other.

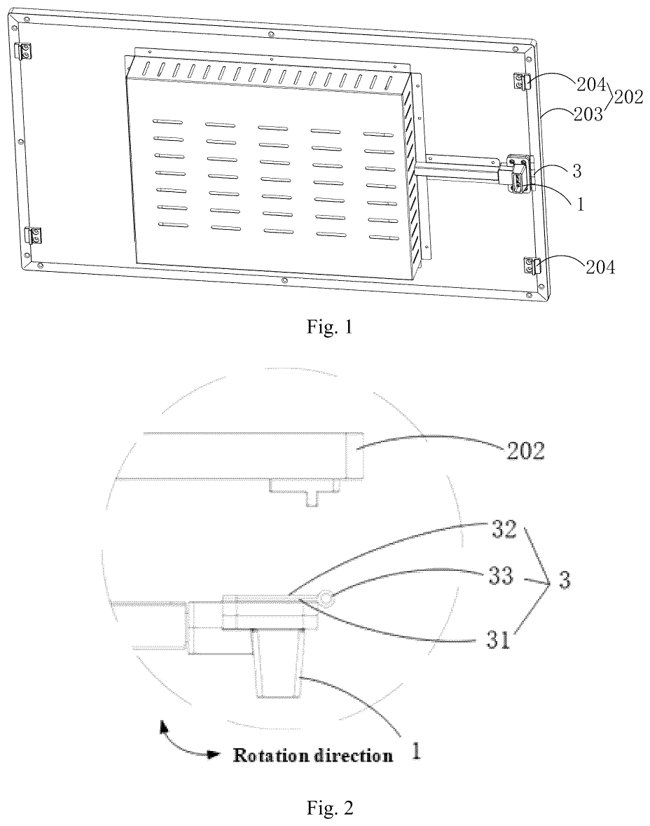

As shown in FIGS. 1 and 2, embodiments of the present application disclose a functional module 202.

The functional module 202 is configured on a dining cart 200, and the dining cart 200 includes a cart body 201, the functional module 202 and an upper coupling 1. The functional module 202 is detachably fixed to the cart body 201, and the upper coupling 1 is rotationally arranged on the functional module 202 through a rotating part 3 such as a hinge. The functional module 202 is coupled onto the cart body 201 by inserting the upper coupling 1 into a lower coupling 2. The functional module 202 includes a body 203 and limiting blocks 204. The upper coupling 1 is arranged at one end of the body 203 and faces one side of the cart body 201.

Specifically, the number of the limiting blocks 204 may be one, two, three, four, etc. The specific number of the limiting blocks 204 is not limited, and is preferably two, and the two limiting blocks are arranged on both sides of the upper coupling 1, so that the functional module 202 can be uniformly stressed.

The rotating part 3 may be the hinge or the like, and the rotating part 3 is arranged between the upper coupling 1 and the functional module 202. As shown in FIG. 2, the hinge includes a first rotating plate 31, a second rotating plate 32, a first shaft sleeve 33 and a second shaft sleeve (not shown). The first rotating plate 31 is fixed to the first shaft sleeve 33, and the second rotating plate 32 is fixed to the second shaft sleeve. The first shaft sleeve 33 and the second shaft sleeve are rotationally connected by a pin. The first rotating plate 31 is fixed onto the upper coupling 1, and the second rotating plate 32 is fixed to the functional module 202, so that the upper coupling 1 can be opened at certain angle (as shown in FIG. 2), and one end of the functional module 202 is lifted without limiting the position of the upper coupling 1 and damaging the plug.

FIG. 1 is a schematic diagram showing one type of functional module 202, and the specific structure of the functional module 202 is not limited. The functional module 202 includes any one of a heating module, a heat preservation module and a cold preservation module. The heating module may be a heating device such as an induction cooker, an electric oven and a gas stove, the heat preservation module may be a control panel with a constant temperature function, and the cold preservation module may be a cold preservation control panel with a cold preservation function. The functional modules 202 of the same function may be installed on the cart body 201 at the same time, or different functional modules 202 may be installed on the cart body 201 according to actual requirements, so that the dining cart 200 can achieve the effects of heating, heat preservation, refrigeration or freshness keeping of food.

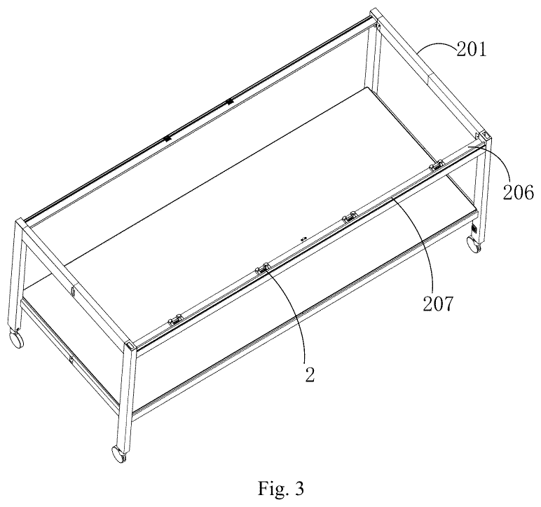

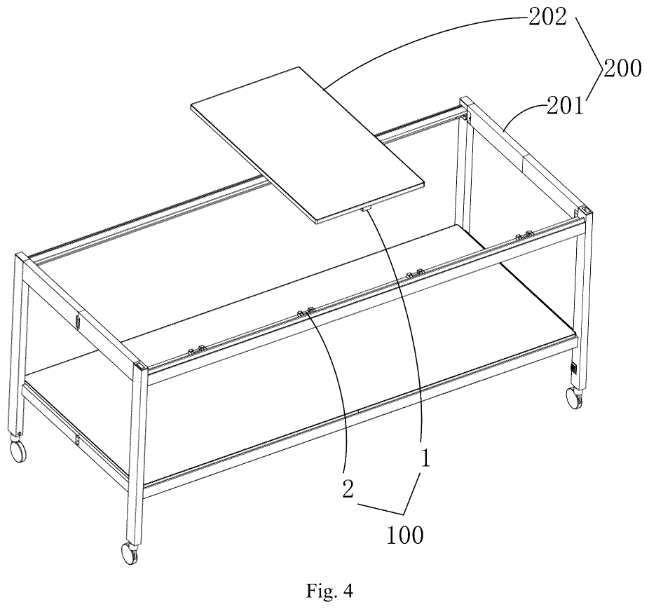

As shown in FIG. 3, embodiments of the present application also disclose a cart body 201. A dining cart 200 includes the cart body 201, a functional module 202 and a lower coupling 2. The functional module 202 is detachably arranged on cross beams 205 of the cart body 201, and the lower coupling 2 is fixed on the cart body 201. A upper coupling 1 is rotationally arranged on the functional module 202 through a rotating part such as a hinge, and the functional module 202 is coupled onto the cart body 201 by inserting the upper coupling 1 into the lower coupling 2. The cart body 201 includes the cross beams 205 and supporting legs, and the cross beams 205 are transversely arranged between the supporting legs to form a frame. The cross beam 205 includes a body 203 of the cross beam 205 and a limiting plate 207 protruding along the body 203 of the cross beam 205.

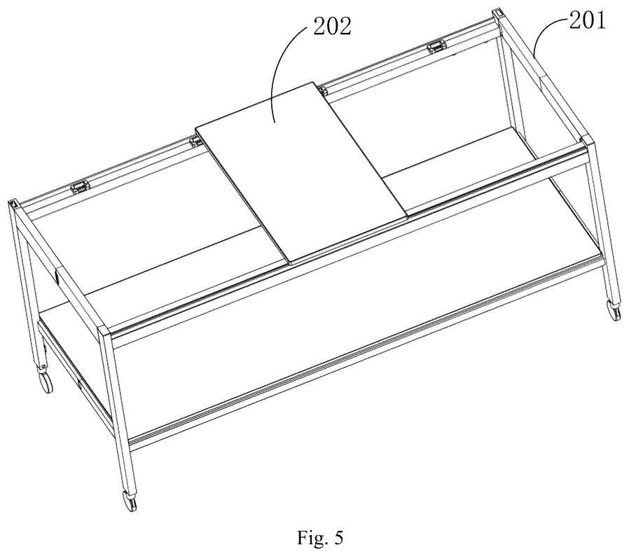

As shown in FIGS. 4 and 5, embodiments of the present application disclose a dining cart 200 with a modular matching function.

The dining cart 200 may be used for banquets or buffets in hotels, and the practicability and intelligence of the dining cart 200 are improved by using the multifunctional module 202. The functional module 202 includes any one of a heating module, a heat preservation module and a cold preservation module. The heating module may be a heating device such as an induction cooker, an electric oven and a gas stove, the heat preservation module may be a control panel with a constant temperature function, and the cold preservation module may be a cold preservation control panel with a cold preservation function. The functional modules 202 of the same function may be installed on the cart body at the same time, or different functional modules 202 may be installed on the cart body according to actual requirements, so that the dining cart 200 can achieve the effects of heating, heat preservation, refrigeration or freshness keeping of food.

The dining cart 200 includes a cart body 201, a functional module 202 and a coupler 100. The coupler 100 includes an upper coupling 1 and a lower coupling 2. The upper coupling 1 is rotationally fixed on the functional module 202 through a rotating part 3. The functional module 202 includes a body 203 and limiting blocks 204. The upper coupling 1 is arranged at one end of the body 203 and faces one side of the cart body 201. The cart body 201 includes cross beams 205 and supporting legs (not shown). The cross beams 205 are transversely arranged between the supporting legs to form a frame. The cross beam 205 includes a cross beam body 206 and a limiting plate 207 protruding along the cross beam body. The lower coupling 2 is fixed on the cross beam bodies 206 of the cart body 201. When the functional module 202 is installed on the cart body 201, firstly, the functional module 202 is placed roughly above a position on the cart body 201 where the functional module 202 needs to be placed; then pins 10 of the upper coupling 1 are aligned with jacks 20 of the lower coupling 2, and subsequently the pins 10 are inserted into the jacks 20; and meanwhile, a first limiting structure 11 of the upper coupling 1 is inserted into a second limiting structure 21 of the lower coupling 2, the second limiting structure 21 restricts the movement of the first limiting structure 11 and the functional module 202 is fixed on the upper coupling 1, so that the coupler 100 can limit the functional module 202. The limiting blocks 204 are abutted against limiting plates 207 to limit the functional module 202, which further strengthens stability of the functional module 202. The functional module 202 and the cart body 201 are connected together through the upper coupling and the lower coupling 2 of the coupler 100, so that the installation of the functional module 202 and the cart body 201 is simpler, and there is no need for a user to squat down to pull a power cord with a plug, and then insert the plug into a socket.

The number of the limiting blocks 204 may be one, two, three, four, etc. The specific number of the limiting blocks 204 is not limited, and is preferably two, and the limiting blocks 204 are arranged on both sides of the upper coupling 1, so that the functional module 202 can be uniformly stressed.

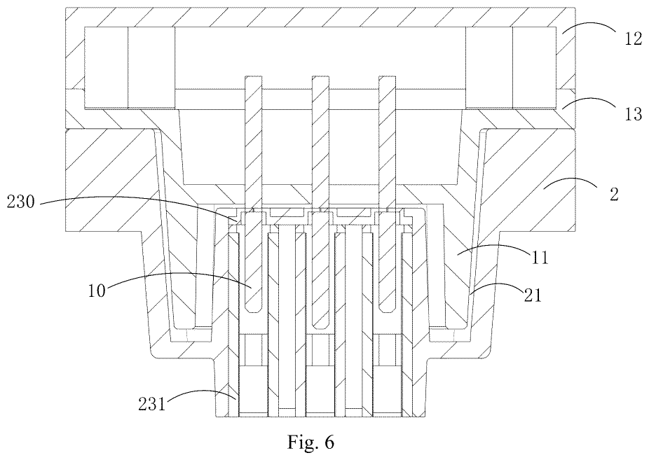

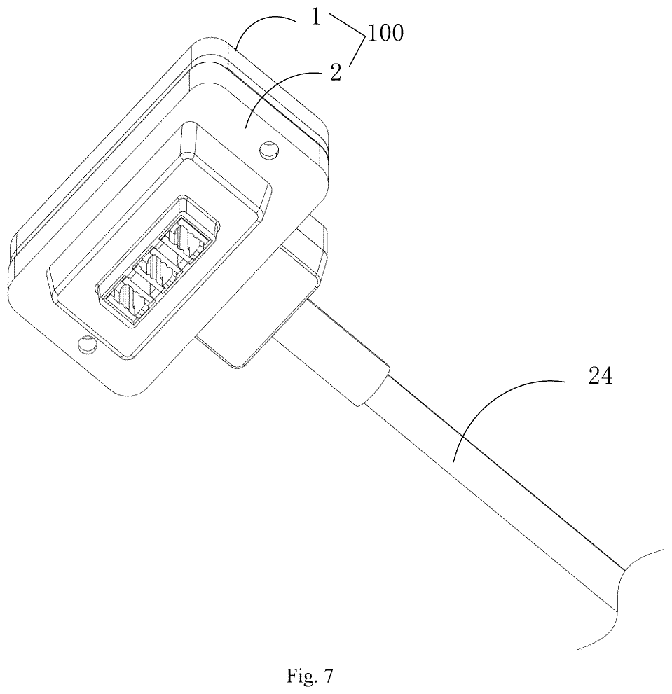

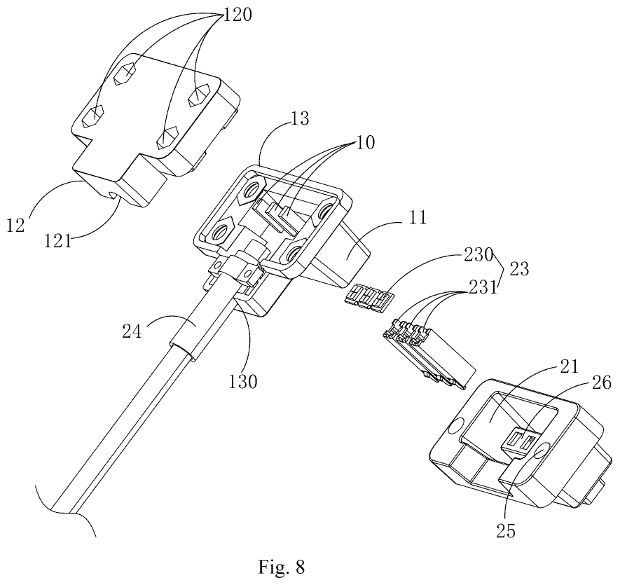

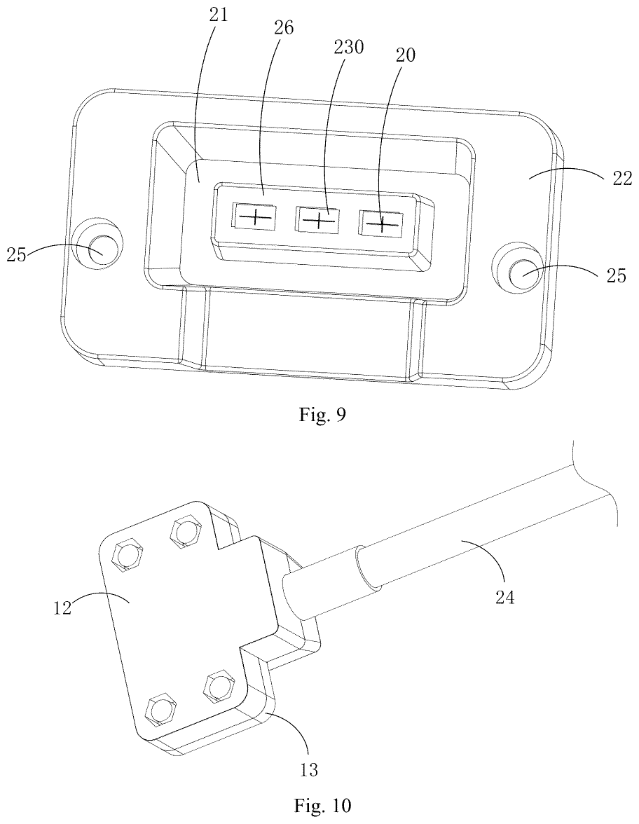

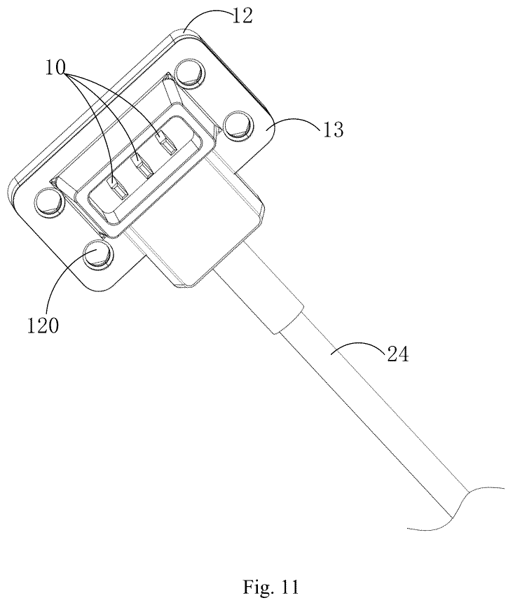

Referring to FIGS. 6 to 16, embodiments of the present application also disclose a coupler 100 with upper and lower couplings.

In one embodiment, as shown in FIGS. 6 to 16, the coupler 100 includes an upper coupling 1 and a lower coupling 2 which are coupled, and a functional module 202 is coupled onto the cart body 201 by inserting the upper coupling 1 into the lower coupling 2. The upper coupling 1 includes an upper cover 12 with a first notch 121, a lower cover 13 with a second notch 130 and a power cord 24, and the first notch 121 and the second notch 130 are both semicircular. Therefore, when the upper cover 12 covers the lower cover 13, the first notch 121 and the second notch 130 form a threading hole and a hollow cavity for the power cord 24 to pass through, which realizes internal and external electrification of the upper coupling 1. In the present embodiment, the upper cover 12 and the lower cover 13 are of an integrated structure, and are connected into a whole in a welding mode, so that the process flow is reduced, the cost is reduced, the structure is simple and high convenience in assembling is realized. The pins 10 are fixed on the outer surface of one side of the lower cover 13 facing the lower coupling 2, and penetrate the outer surface to enter the hollow cavity to be electrically connected with one end of the power cord 24, and the other end of the power cord 24 is electrically connected with an external power supply, thereby realizing the internal and external electrification of the upper coupling 1.

Further, the upper cover 12 is provided with a plurality of first fixing holes 120, wherein the number of the first fixing holes 120 may be two or four, etc., and the upper coupling is fixed on the functional module 202 by screws and bolts, so that the upper coupling 1 is convenient to assemble and disassemble.

The first limiting structure 11 is fixed on one outer surface of the lower cover 13, and the first limiting structure 11 is arranged around the periphery of the pins 10, so that the first limiting structure 11 surrounds all the pins 10.

The lower coupling 2 includes a fixing seat 22 and a conductive assembly 23, and the conductive assembly 23 includes a conductive plate 230 and a plurality of tubular conductors 231. The second limiting structure 21 is arranged in the fixing seat 22, and a blocking part 26 is fixed on the fixing seat 22 and located in the second limiting structure 21. The conductive plate 230 is embedded in the end surface of one side of the blocking part 26 facing the pins 10, and the plurality of tubular conductors 231 are all electrically connected with the conductive plate 230. The tubular conductors 231 are located in the blocking part 26, and the blocking part 26 plays a role in protecting the tubular conductors 231 and further cooperates with the second limiting structure 21 to better limit the first limiting structure 11. Jacks 20 are arranged in the conductive plate 230, and each jack 20 is communicated with a corresponding tubular conductor 231, so that each pin 10 can be inserted into the tubular conductor 231 through the corresponding jack 20, thereby realizing the energization of the upper coupling 1 and the lower coupling 2. In addition, the first limiting structure 11 is clamped in the second limiting structure 21 adapted to the first limiting structure 11, and the first limiting structure 11 and the second limiting structure 21 are locked with each other. Therefore, the second limiting structure 21 limits the movement of the first limiting structure 11, that is, the lower coupling 2 limits the upper coupling 1. Since the upper coupling 1 is fixed on the functional module 202, the lower coupling 2 also limits the functional module 202 to some extent, so that the assembled functional module 202 is not easily shifted; and meanwhile the poor contact or short circuit caused by damage to the pins 10 after displacement of the upper coupling 1 is also avoided. The functional module 202 and the cart body 201 are connected together through the upper coupling and the lower coupling of the coupler 100, so that the installation of the functional module 202 and the cart body 201 is simpler, and there is no need for the user to squat down to pull the power cord with the plug, and then insert the plug into the socket.

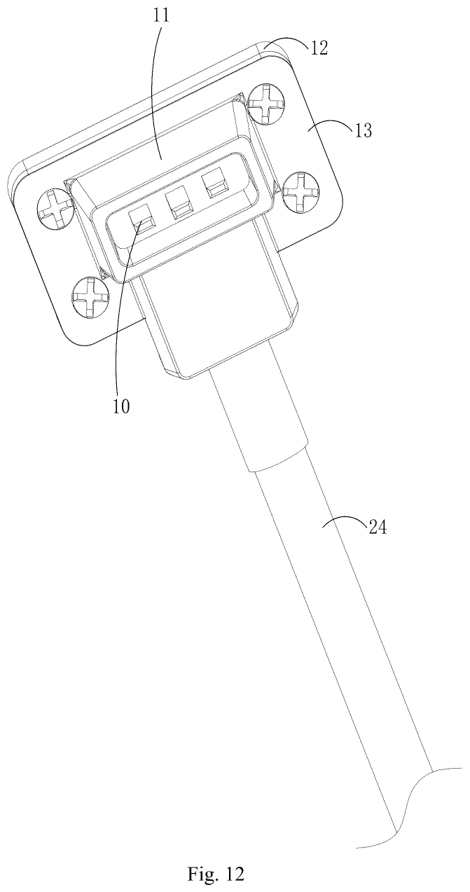

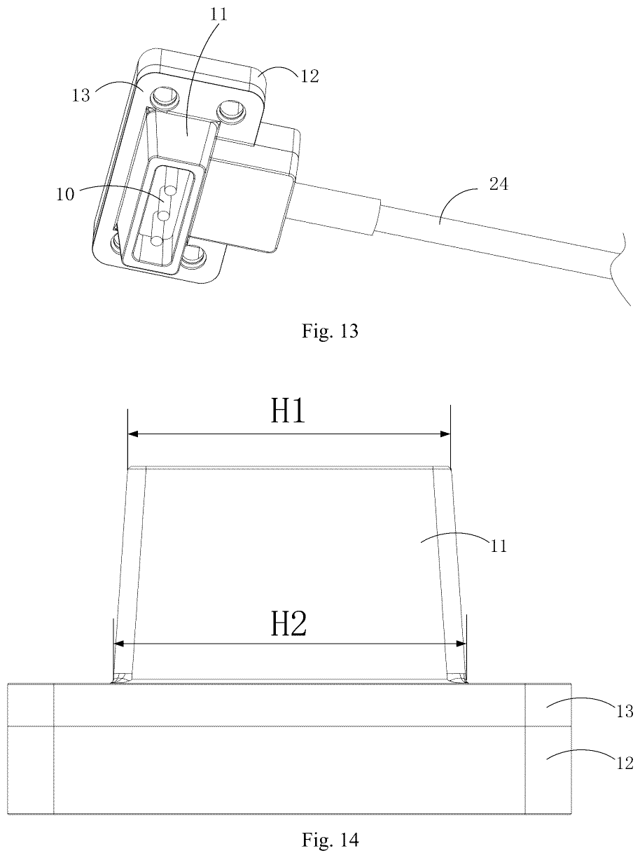

Specifically, three pins 10 are arranged, and are a ground line pin 10, a zero line pin 10 and a live line pin 10 respectively. There are three jacks 20 corresponding to the pins 10, and there are three tubular conductors 231 corresponding to the pins 10. Each pin 10 is inserted into a corresponding socket 20 to be electrically connected with each tubular conductor 231, so as to realize electrical connection of the coupler 100. The three pins 10 are distributed side by side, the ground line pin 10 is located between the zero line pin 10 and the live line pin 10, and the arrangement is compact, so that the coupler 100 has a simple structure. As shown in FIGS. 6, 8 and 11, cross sections of the pins 10 are flat, and the pins 10 are vertically distributed side by side. As shown in FIG. 12, the pins 10 are flat, and the pins 10 are transversely distributed side by side. The difference between the vertical side-by-side distribution and the transverse side-by-side distribution is that the pins 10 are rotated by 90 degrees in the vertical side-by-side distribution. As shown in FIG. 13, the cross sections of the pins 10 are circular.

Further, as shown in FIGS. 1 and 2, the upper coupling 1 is rotationally arranged on the functional module through a rotating part 3, and the rotating part 3 may be a hinge or the like, and is arranged between the upper coupling 1 and the functional module 202. The hinge includes a first rotating plate 31, a second rotating plate 32, a first shaft sleeve 33 and a second shaft sleeve. The first rotating plate 31 is fixed on the first shaft sleeve 33, and the second rotating plate 32 is fixed on the second shaft sleeve. The first shaft sleeve 33 and the second shaft sleeve are rotationally connected by a pin. The first rotating plate 31 is fixed on the upper coupling 1, and the second rotating plate 32 is fixed on the functional module 202, so that the upper coupling 1 can be opened at certain angle and one end of the functional module 202 is lifted without limiting the position of the upper coupling 1 and damaging the plug.

Further, the lower coupling 2 also includes waterproof silica gel sheets (not shown), and the waterproof silica gel sheets are arranged in the jacks 20, so that the coupler 100 has a waterproof effect. Furthermore, the lower coupling 2 is also provided with two second fixing holes 25, which are located at two sides of the fixing seat 22 respectively, and the cart body 201 is provided with through holes corresponding to the second fixing holes 25. The second fixing holes 25 are aligned with the through holes, and then fasteners such as screws and bolts are inserted into the second fixing holes 25 and the through holes in turn, and are screwed by rotating, so that the lower coupling 2 can be fixed on the cart body 201 by rotating and screwing the fasteners.

In one embodiment, as shown in FIG. 14, the width H2 of one end of the first limiting structure 11 close to the functional module 202 is greater than the width H1 of the opposite end of the first limiting structure 11, that is, the width H2 of one end of the first limiting structure 11 close to the lower cover 13 is greater than the width H1 of the opposite end of the first limiting structure 11, and the width H1 of the other end of the first limiting structure 11 is small, so that the first limiting structure 11 has a structure of which one end is large and the other end is small, that is, in an inclined state. The width of one end of the second limiting structure 21 close to the cart body 201 is less than the width of the opposite end of the second limiting structure 21, so that the second limiting structure 21 has a structure of which one end is small and the other end is large, that is, in an inclined state. The first limiting structure 11 and the second limiting structure 21 are obliquely clamped. According to the mechanical principle, when the user operates on the functional module 202, the functional module 202 gives the upper coupling 1 a downward pressure. Under an inclination action of the downward pressure, the first limiting structure 11 presses the second limiting structure 21 more and more tightly, so that the upper coupling 1 and the lower coupling 2 are more firmly clamped, and the second limiting structure 21 limits the first limiting structure 11 therein to avoid shifting of the upper coupling 1, thereby achieving positioning of the functional module 202. The positioning may also be understood as limiting.

Further, the first limiting structure 11 is a hollow protrusion, that is, the hollow protrusion is fixed on and protrudes out of the lower cover 13, and the pins 10 are arranged in a hollow position of the hollow protrusion, so that the hollow protrusion surrounds the pins 10 and plays a role in protecting the pins 10. The second limiting structure 21 is a groove, and the hollow protrusion is embedded in the groove during coupling. Side walls of the hollow protrusion are inclined surfaces, and inner side walls of the groove are inclined surfaces, so that the upper coupling 1 and the lower coupling 2 are more firmly connected due to clamping of the inclined surfaces, and it is convenient for the upper coupling to slide into the lower coupling due to the design of the inclined surfaces.

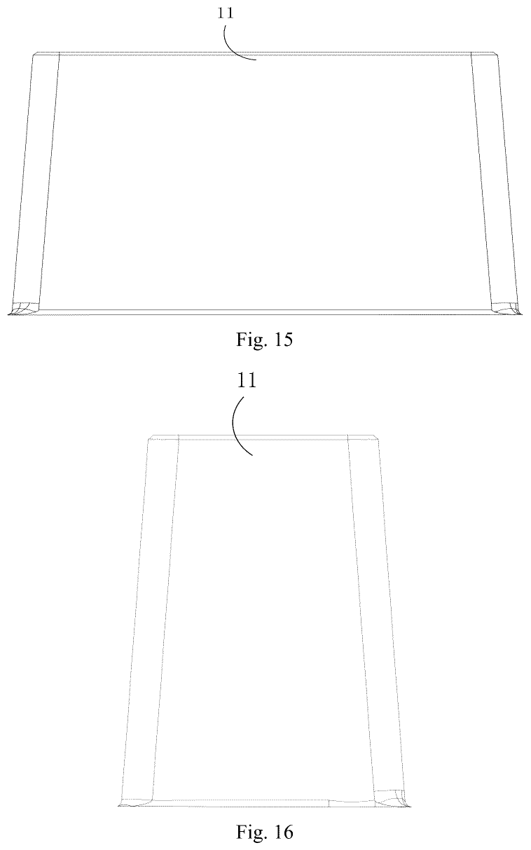

Further, as shown in FIG. 9, the cross section of the hollow protrusion is a rectangle, and the rectangle may be an oblong or square, optionally oblong. Specifically, the hollow protrusion includes four side walls, as shown in FIGS. 15 and 16, the two opposite side walls are equilateral trapezoids with the same size, that is, a structure obtained by the fact that one end of the hollow protrusion arranged at the lower cover 13 gradually becomes smaller along center lines of the rectangle, the cross section of the groove is a rectangle adapted to the hollow protrusion, and the hollow protrusion is inserted into the groove. The rectangles have four corners, and thus can limit each other, so that the hollow protrusion and the groove can stop each other from displacement and rotation, thereby positioning the functional module 202. Besides, the four corners are rounded to prevent the user from being scratched by too sharp corners, and meanwhile, the first limiting structure 11 and the second limiting structure 21 are prevented from being damaged by direct collision.

The above embodiments are only used to illustrate the technical solutions of the present application, and are not intended to limit the same. Under the idea of the present application, combinations can be made between the above embodiments or between the technical features in different embodiments, and the steps can be realized in any order; and there are many other variations of the different aspects of the present application as described above, which have not been provided in detail for the sake of conciseness. Despite the detailed description of the present application with reference to the foregoing embodiments, a person of ordinary skill in the art should understand that it is still possible to modify the technical solutions recorded in the foregoing embodiments or to make equivalent substitutions for some of the technical features therein; and such modifications or substitutions do not take the essence of the corresponding technical solutions out of the scope of the technical solutions of the embodiments of the present application.

What is claimed is:

1. A coupler with upper and lower couplings, configured for a dining cart with a modular matching function,
wherein the dining cart comprises a cart body and a functional module, the functional module being detachably arranged on the cart body; and the coupler comprises an upper coupling and a lower coupling, and
wherein the upper coupling is arranged on the functional module, the lower coupling is correspondingly arranged on the cart body, the upper coupling is provided with pins and a first limiting structure arranged around the periphery of the pins, the lower coupling is provided with jacks for insertion of the pins and a second limiting structure adapted to the first limiting structure, and during coupling, the pins of the upper coupling are inserted into the jacks of the lower coupling and the first limiting structure is clamped in the second limiting structure to form locking to restrict the upper coupling from moving.

2. The coupler according to claim 1, wherein
a width of one end of the first limiting structure close to the functional module is greater than a width of an opposite end thereof,
a width of one end of the second limiting structure close to the cart body is less than a width of an opposite end thereof, and
the first limiting structure is inserted into the second limiting structure to form locking to restrict the upper coupling from moving.

3. The coupler according to claim 2, wherein
the first limiting structure is a hollow protrusion,
the pins are arranged in a hollow position of the hollow protrusion,
the second limiting structure is a groove, and
the hollow protrusion is embedded in the groove to restrict the upper coupling from moving.

4. The coupler according to claim 3, wherein
a cross section of the hollow protrusion is a rectangle,
a cross section of the groove is a rectangle adapted to the hollow protrusion, and
the hollow protrusion is inserted into the groove to stop each other.

5. The coupler according to claim 1, wherein the upper coupling is rotationally arranged on the functional module through a rotating part.

6. The coupler according to claim 1, wherein the lower coupling further comprises a fixing seat, a conductive assembly and a blocking part, wherein
the second limiting structure is arranged on the fixing seat;
the blocking part is arranged on the fixing seat and is located in the second limiting structure; and
the conductive assembly comprises a conductive plate and a plurality of tubular conductors, the conductive plate being embedded in one side of the blocking part facing the pins, and the plurality of tubular conductors being all arranged on the conductive plate and located in the blocking part; and the jacks are arranged in the conductive plate, and each jack is communicated with one corresponding tubular conductor.

7. The coupler according to claim 6, wherein three pins are arranged, three jacks are correspondingly arranged, three tubular conductors are correspondingly arranged, and each pin is inserted into one corresponding jack to be electrically connected with one corresponding tubular conductor.

8. The coupler according to claim 1,
wherein the upper coupling comprises an upper cover with a first notch, a lower cover with a second notch, and a power cord, and
wherein the upper cover covers the lower cover, the first notch and the second notch form a threading hole, one end of the power cord passes through the threading hole to be electrically connected with the pins, and the other end of the power cord is electrically connected with an external power supply device.

9. The coupler according to claim 1, wherein
the lower coupling further comprises waterproof silica gel sheets arranged in the jacks; and/or
the lower coupling is also provided with second fixing holes.

10. A functional module, configured on a dining cart,
wherein the dining cart comprises a cart body, the functional module and an upper coupling, and
wherein the upper coupling is arranged on the functional module, the upper coupling is provided with pins and a first limiting structure arranged around the periphery of the pins, and the functional module is detachably arranged on the cart body through the pins and the first limiting structure.

11. A cart body, configured on a dining cart,
wherein the dining cart comprises the cart body, a functional module and a lower coupling, and
wherein the lower coupling is arranged on the cart body, the lower coupling is provided with jacks and a second limiting structure, and the cart body is detachably arranged on the functional module through the jacks and the second limiting structure.

12. A dining cart with a modular matching function, comprising a cart body, a functional module and a coupler,
wherein the functional module is detachably arranged on the cart body; and the coupler comprises an upper coupling and a lower coupling, and
wherein the upper coupling is arranged on the functional module, the lower coupling is correspondingly arranged on the cart body, the upper coupling is provided with pins and a first limiting structure arranged around the periphery of the pins, the lower coupling is provided with jacks for insertion of the pins and a second limiting structure adapted to the first limiting structure, and during coupling, the pins of the upper coupling are inserted into the jacks of the lower coupling, and the first limiting structure is clamped in the second limiting structure to form locking to restrict the upper coupling from moving.

13. The dining cart according to claim 12, wherein a width of one end of the first limiting structure close to the functional module is greater than a width of an opposite end thereof, a width of one end of the second limiting structure close to the cart body is less than a width of an opposite end thereof, and the first limiting structure is inserted into the second limiting structure to form locking to restrict the upper coupling from moving.

14. The dining cart according to claim 13, wherein the first limiting structure is a hollow protrusion, the pins are arranged in a hollow position of the hollow protrusion, the second limiting structure is a groove, and the hollow protrusion is embedded in the groove to restrict the upper coupling from moving.

15. The dining cart according to claim 14, wherein a cross section of the hollow protrusion is a rectangle, a cross section of the groove is a rectangle adapted to the hollow protrusion, and the hollow protrusion is inserted into the groove to stop each other.

16. The dining cart according to claim 12, wherein the upper coupling is rotationally arranged on the functional module through a rotating part.
